(19) United States
(12) Patent Application Publication
(10) Pub. No.: US 2010/0269498 A1
(43) Pub. Date: Oct. 28, 2010

(54) SYSTEMS FOR CONVERSION, STORAGE, AND DISTRIBUTION OF ENERGY FROM RENEWABLE AND NONRENEWABLE SOURCES

(76) Inventor: Paul Troy Wright, Greenville, SC (US)

Correspondence Address: TURNER PADGET GRAHAM & LANEY, P.A., P.O. BOX 1509, GREENVILLE, SC, 29602, US

(21) Appl. No.: 12/766,612

(22) Filed: Apr. 23, 2010

Related U.S. Application Data
(60) Provisional application No. 61/173,365, filed on Apr. 28, 2009.

(51) Int. Cl. F03B 17/02; C25B 9/00; C25B 1/02; F17D 1/16; F04D 15/00

(52) U.S. Cl. 60/495; 204/275.1; 204/278; 205/637; 137/14; 415/182.1

(57) ABSTRACT

A system and method for converting, storing and distributing energy from renewable and non-renewable sources is provided, particularly a system to convert, store and distribute energy in the form of chemical energy in hydrogen (H₂). A vertical-axis radial-flow turbine is also provided for the conversion of energy from renewable and non-renewable sources, such as solar energy, wave energy, and wind energy. Further provided herein is a multiple-column flow-control oscillating water column generator for the conversion of energy from wave and wind energy.

### CROSS-REFERENCE TO RELATED APPLICATIONS

This utility patent application claims benefit of U.S. Provisional Application Ser. No. 61/173,365, filed Apr. 28, 2009, which is incorporated herein in its entirety by reference thereto.

### BACKGROUND

The use of fossil fuel to generate electricity presently accounts for a significant portion of the environmental impacts attributable to fossil fuels. Those impacts include emissions that cause air pollution and may contribute indirectly to climate change. Furthermore, when fuel is combusted to generate electricity for the conventional electrical grid, at most only about one-third (˜33%) of the released energy actually reaches end users in the form of useful energy. The remaining two-thirds or more (˜67%) of the released energy is lost to “waste heat” and other forms of thermal pollution that directly contribute to global warming. Those energy losses are inherent in the existing generating and grid structure and cannot be avoided with the existing structure, due to the principles embodied in Ohm's Law and the Second Law of Thermodynamics. Also, the grid is fragile and does not store electricity, resulting in outages that cause tremendous economic and social losses.

It is possible to address those and other shortcomings of the existing structure for generating and distributing electricity over the grid, with a “distributed generation” structure that delivers clean fuel to generate electricity locally when and where needed. Distributed generation with clean fuel not only avoids the environmental impacts and electrical losses inherent in the existing structure, but further allows waste heat (that is, thermal energy) from local generators to be captured and used for heating, cooling, and other purposes. The capture and use of waste heat from generators is known as “co-generation,” and is not feasible with the existing generating and distribution structures because thermal energy cannot be directly transmitted effectively over long distances. For a given amount of fuel consumption, distributed co-generation will deliver significantly more useful energy than the existing structure.

One potential clean fuel source for distributed co-generation is hydrogen gas (H₂), because it is the most energy-dense known combustible fuel by mass and burns very cleanly without the emissions characteristic of fossil fuels. Furthermore, hydrogen is the most abundant element on the planet and may be isolated using simple technology.

Unfortunately, certain characteristics of hydrogen in gaseous form limit its widespread use as a fuel when using technology available before this disclosure. As a volatile gas, H₂ is subject to explosion if ignited while in a closed container. As a very small molecule, H₂ tends to leak from containers when under pressure. In addition, H₂ is less energy dense by volume compared to many other combustible fuels, unless hydrogen is liquefied at very low temperatures or the hydrogen gas is compressed to very high pressures that exacerbate the stated explosion and leakage risks. These characteristics have heretofore made storage and distribution of H₂ difficult and expensive compared to other combustible fuels.

In order to address the shortcomings of the conventional generating and distributing structure, the energy and electric-utility industries need sustainable means to convert, store, and distribute hydrogen in such a manner as to overcome shortcomings of hydrogen. In another aspect, the electricity-generation market needs effective means to extract energy from various renewable energy sources, regardless of whether such energy is subsequently used for hydrogen gas production.

### SUMMARY

This disclosure is directed in general to systems for converting, storing, and distributing energy from renewable and non-renewable sources. In one aspect, the energy is present in the form of hydrogen (H₂) dissolved in water (H₂O) under pressure. In this and other aspects, a vertical-axis radial-flow turbine may be employed to capture mechanical energy. In yet another aspect, an oscillating water column may be used to capture and convert wave energy to a usable form.

According to one aspect, the systems described herein provide sustainable means to convert various forms of energy into chemical energy in the form of hydrogen, and to store and distribute hydrogen for use as fuel to generate electricity and for other purposes. Among other advantages, the present systems minimize adverse environmental impacts from the use of fossil fuels to generate electricity, as well as energy losses, thermal pollution, and risk of outages inherent in the existing generating and grid structures.

The described systems further avoid the electrical challenges inherent in interconnecting generating sources to the existing electrical grid, including the need to match voltage and frequency, as well as the need to balance total generating output with total load and the need to balance output and load across multiple electrical phases. By avoiding these issues, large numbers of energy sources of many kinds and capacities may be effectively used to provide energy when and where needed. The present systems are capable of providing energy even from renewable sources that are not necessarily optimal at times or in locations where energy is needed.

To this end, energy from renewable sources (such as wave energy, solar energy, and wind energy) may effectively be captured and stored for later use, perhaps even in a location remote to the collection of the energy. One or more of these energy sources may be employed to assist in the conversion, storage, and distribution of hydrogen gas as a fuel, whenever and wherever the fuel may be needed. The present conversion, storage, and distribution systems maintain their functionality regardless of the vagaries of supply in the original energy sources. For example, wave energy is optimal under certain weather conditions on bodies of water large enough to allow the wind to create sufficiently large waves. Similarly, solar energy is optimal in certain areas and only during hours of sufficient sunshine. Likewise, wind energy is optimal only under certain weather conditions in certain areas.

In the first aspect, the present systems allow the dissolution of hydrogen in water under pressure in a pipeline where and when energy is available and the depressurization of some of the water from the pipeline to extract H₂ where and when needed for use as fuel or for other purposes. The dissolution of hydrogen in water minimizes risks of leakage and explosion by converting H₂ to a non-gaseous state and allows hydrogen to migrate through the pipeline on a molecular level in solution from areas of high concentration to areas of low concentration without significant movement of hydrogen-saturated water. While some hydrogen-saturated water is removed in order to extract H₂, that water may then be pumped back into the pipeline where removed, in order to maintain the water supply and pipeline pressure. Hydrogen will move through the pipeline on a molecular level as equilibrium forces inherent in aqueous solutions cause hydrogen to migrate from areas of higher to lower concentrations. When some H₂ is removed from a point in the pipeline, for example, equilibrium forces will cause remaining hydrogen to migrate in solution toward the lower concentration areas. Similarly, as H₂ is pumped into the pipeline at a certain point, equilibrium forces will cause that hydrogen to migrate in solution toward areas of lower concentration.

A pressure higher than atmospheric pressure is employed to keep hydrogen gas dissolved in water. At atmospheric pressure, only about 0.0016 grams of hydrogen gas will dissolve in 1 kilogram of water. Exploiting the principles of Henrys Law, however, an increase in pressure results in a linear increase in the amount of hydrogen that may be dissolved in water. For example, at a pressure of 2,500 p.s.i., approximately 171 times more hydrogen will dissolve in a given amount of water as compared to the amount that may be dissolved in water at atmospheric pressure. Further, by using pressure to dissolve hydrogen gas into an aqueous solution, many of the undesirable properties of the hydrogen gas alone are negated.

The pressure in the pipeline and equilibrium forces in the aqueous solution work together in such a way that, if any hydrogen in an area of temporary localized high concentration within the pipeline were to come out of solution and return to a gaseous state, the resulting localized increase in pressure (from the increased volume of H₂ in a closed space) will tend to return the H₂ to solution where equilibrium forces will cause the hydrogen to migrate toward an area of lower concentration.

In the extreme case of a break in the pipeline causing H₂ to come out of solution and escape from the pipeline, the H₂ will not create a lasting adverse environmental impact but instead will tend to disperse rapidly in the atmosphere where H₂ already exists naturally. If H₂ were released from the pipeline and somehow ignited before being dispersed to the non-volatile concentrations that occur naturally in air, the H₂ would be completely consumed almost instantly with only thermal energy and water as the byproducts of combustion—most likely resulting in an implosion rather than an explosion (as generations of middle-school students have observed when H₂ is ignited in an upside-down test tube in the classic chemistry-class demonstration of electrolysis of water).

In order to deliver sufficient amounts of hydrogen, the pipelines described herein will be located at ground level and will be constructed much more massively than the electric transmission lines of the conventional grid. As a result, these pipelines are less likely to be damaged by hurricanes and other storms that often knock down or otherwise disable electric transmission lines, resulting in extended service outages. In contrast, by using the present systems, electrical service likely will remain undisturbed, despite inclement weather. Moreover, in those instances where the system employs wind and/or wave generators, additional energy from the storms may be accumulated and converted into a greater supply of usable energy.

Even in the extreme case of complete loss of all generating capacity used to produce H₂, whether due to storm or other cause, a supply of hydrogen will remain dissolved in water in pipelines and will thus be available for local generation of electricity for some period of time. In essence, the pipelines of the present system, which are filled with hydrogen-saturated water, will eliminate the risk of grid outage by serving as a massive “battery” holding stored energy that can be cleanly and readily converted into electrical and thermal energy even when no H₂ is being produced.

In further contrast with the transmission lines of the existing electric grid where wide swaths of land must have vegetation removed because of the fragility of the lines, the land surface and space above hydrogen-distribution rights-of-way may be used concurrently in a constructive manner, such as for transportation rights-of-way or parks. This contrasts starkly with the “wasteland” and “eyesore” characteristics associated with transmission lines of the existing electrical grid.

Another benefit of the present systems is that the use of H₂ in a fuel cell or the combustion of H₂ in air will produce water in addition to thermal energy. The use of the present systems to distribute hydrogen for use as fuel in distributed generation thus also constitutes the distribution of usable clean water.

By allowing storage and distribution of hydrogen, and the metering of H₂ going in and out, the present systems enable a “hydrogen economy” in which hydrogen can serve as a universal medium of economic exchange.

According to the first aspect, provided herein is a water-filled pipeline between a place where an input energy source is located and a place where hydrogen or other energy is used. The contemplated energy sources include renewable sources, such as wind, solar, hydro, geothermal, wave, bio-mass, and waste energies, as well as non-renewable sources, such as fossil and nuclear fuels. The pipeline may be constructed of or lined with non-reactive material, to address chemical and metallurgical consequences of dissolving hydrogen in water.

A generating station may be provided to produce electricity from various energy sources, including renewable and non-renewable sources. The generating station may use various means for converting energy into electricity, including, but not limited to, a vertical-axis radial-flow turbine that can extract mechanical energy simultaneously from multiple energy sources with flows from multiple directions and vertical heights relative to the turbine axis.

An electrolysis station or other process to produce and collect H₂ may further be employed.

A supply of water, a pump to inject water into the pipeline, and a relief valve to release water from the pipeline may be used, as well as a pressure-detecting system and a hydrogen-detecting system, the latter systems being used to control the pump and relief valve to maintain desired pressure in the pipeline so as to maintain hydrogen fully dissolved in the water in the pipeline without exceeding desired pipeline pressure.

The present systems may also incorporate a pump to inject H₂ into the pipeline under pressure and a metering device to detect the amount of H₂ being injected into the pipeline.

A means for removing H₂ from the pipeline may include, but is not limited to, a vent valve and related equipment for removing H₂ from the pipeline by removing and depressurizing water. A control device may be used to manipulate the position of the vent valve to regulate the rate at which H₂ is removed from the pipeline.

After the water has been taken out of the pipeline through the vent valve to release H₂, a return pump may be provided to inject water back into the pipeline.

A collecting chamber to collect H₂ and other gasses removed from the pipeline may be used, while a separator isolates H₂ from other gasses removed from the pipeline, and a metering device detects the amount of H₂ being removed from the pipeline.

A tube and a gas pump may be employed to move H₂ to a separate location for use, after being removed from the pipeline.

The H₂ may be used locally, for example, at a fueling station for hydrogen-fueled vehicles or at a local generating plant that employs various methods for generating electricity from the chemical energy in H₂.

A thermal-energy collecting device may recover waste heat from a local use of H₂ for other use such as for heating, cooling, or an industrial process.

When H₂ is used as fuel, a collecting chamber and tube may be supplied to collect and distribute water that is produced.

In another aspect, renewable energy sources (such as wind energy, solar energy, wave energy, thermal energy, and the like) may produce energy that is captured and converted to mechanical energy for powering a generator, for example.

Further, in this aspect, a vertical-axis radial-flow turbine is provided, the turbine having a body defining a central vertical axis; a plurality of vanes disposed about the central axis of the body, each of the vanes being configured to produce lift as a fluid flows across each vane causing the body to rotate, each of the vances extracting energy from the fluid and covering the energy to produce mechanical energy; and means for transferring the mechanical energy to a location apart from the turbine system.

A governor may be used with this turbine to control the flow of fluid. To control the rate of the fluid flow and to direct the fluid flow, a nozzle may be employed with the turbine.

The turbine may also be provided with a manifold to affect the fluid flow. In accordance with this aspect, the body may be made of an electrically conductive material to function as a rotor, and the manifold may be provided with stator windings, such that the rotation of the body relative to the manifold generates electricity.

A plurality of external structures may extend radially from the body to enhance the pressure difference and velocity of fluid flow across the vanes.

In some instances, fluid flow may be produced from the conversion of thermal energy to kinetic energy to create lift across the vanes. The thermal energy may be derived from one or more of solar radiation, geothermal energy, fuel ignition, waste heat, steam, and combinations thereof. Further in this aspect, the thermal energy may be solar radiation that is collected in a thermal chimney, the thermal chimney being provided with a compression stage for increasing the pressure and velocity of the fluid flow.

According to another aspect herein, a system for extracting mechanical energy from wave energy is provided. The system includes a tube; an outflow check valve and an inflow check valve in communication with the tube; a higher-pressure plenum and a lower-pressure plenum, in communication with the tube and the in-flow check valve, respectively; and a turbine in communication with the plenums. The tube has an opening disposed in a body of water, resulting in an internal column of water alternately rising and falling within the tube as a function of a movement of the body of water. The outflow check valve permits air about the internal water column of the tube to flow out of the tube when the water column is rising in the tube and the air pressure increases above the water column to a sufficient higher-than-ambient pressure. The air flowing out of the tube is received by the higher-pressure plenum. The higher-pressure plenum directs airflow to an intake of the turbine, and the lower-pressure plenum draws airflow from an exhaust of the turbine to extract mechanical energy from the passing waves.

The system above may be provided with multiple tubes, each tube having its own in-flow check valve and out-flow check valve.

The turbine of the system may be a vertical-axis radial-flow turbine, as described herein.

A method of extracting mechanical energy using such a system is also provided.

Additional objects and advantages of the present subject matter are set forth in the detailed description provided herein, or will be apparent to those of ordinary skill in the art from their review of such description. Also, it should be further appreciated that modifications and variations to the specifically illustrated, referred and discussed features and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a schematic diagram of a hydrogen fuel system according to an aspect of the disclosure, particularly showing an energy source, a generating station, an electrolysis station, a pipeline, a water supply, a water-injection pump, a metering device, a pressure-detecting system, a relief valve, a hydrogen-injecting pump, a hydrogen-detecting system, a metering device, a vent valve, a collecting chamber, a separator, a gas pump, a transport tube, a local use of H₂, a collecting chamber and tube to recover and distribute water resulting from the use of H₂ as fuel, and a thermal-energy collecting device to recover thermal energy produced by use of H₂ as fuel;

FIG. 2 includes a plan view and an elevational view of a vertical-axis radial-flow turbine as may be used in the generating station of FIG. 1 and may be used in the shown configuration as a wind-powered generator to extract mechanical energy from wind energy to drive a connected generator, pump, or other device;

FIG. 3 is a schematic diagram of a flow-control multiple-tube oscillating water column generator using a vertical-axis radial-flow turbine as in FIG. 2 to extract mechanical energy from wave energy to drive a connected generator or pump or other device; and

FIG. 4 is a schematic diagram of a turbo-charged thermal generator, using a vertical-axis radial-flow turbine as in FIG. 2, which may be used to extract mechanical energy from thermal energy to drive a connected generator, pump, or other device.

### DETAILED DESCRIPTION

Detailed reference will now be made to the drawings in which examples embodying the present subject matter are shown.

The drawings and description included herein are preferred embodiments and are not intended to limit the inventions or any claim. Although the subject matter may be referred to by the phrases or terms “present disclosure,” “present invention,” “invention” and variations throughout this document, these terms are intended to mean one or more possible embodiments and are not intended to, and should not, limit any claims merely because of such reference. The intention is to cover all modifications, equivalents, and alternatives in the character and scope of the inventions.

Like or similar designations of the drawings and description have been used to refer to like or similar parts of various exemplary embodiments. In describing the preferred embodiments, common or similar characteristics are indicated by identical reference numerals, or in the absence of a reference numeral, are evident based upon the drawings or description. The figures are not necessarily to scale and may be shown exaggerated in scale for purposes of clarity and conciseness.

The drawings and detailed description provide a full and written description of the present subject matter, and of the manner and process of making and using various exemplary embodiments, so as to enable one skilled in the pertinent art to make and use them, as well as the best mode of carrying out the exemplary embodiments. The examples set forth in the drawings and detailed descriptions are provided by way of explanation only, however, and are not meant as limitations of the disclosure. The present subject matter thus includes any modifications and variations of the following examples as come within the scope of the appended claims and their equivalents.

### Hydrogen Energy Embodiment

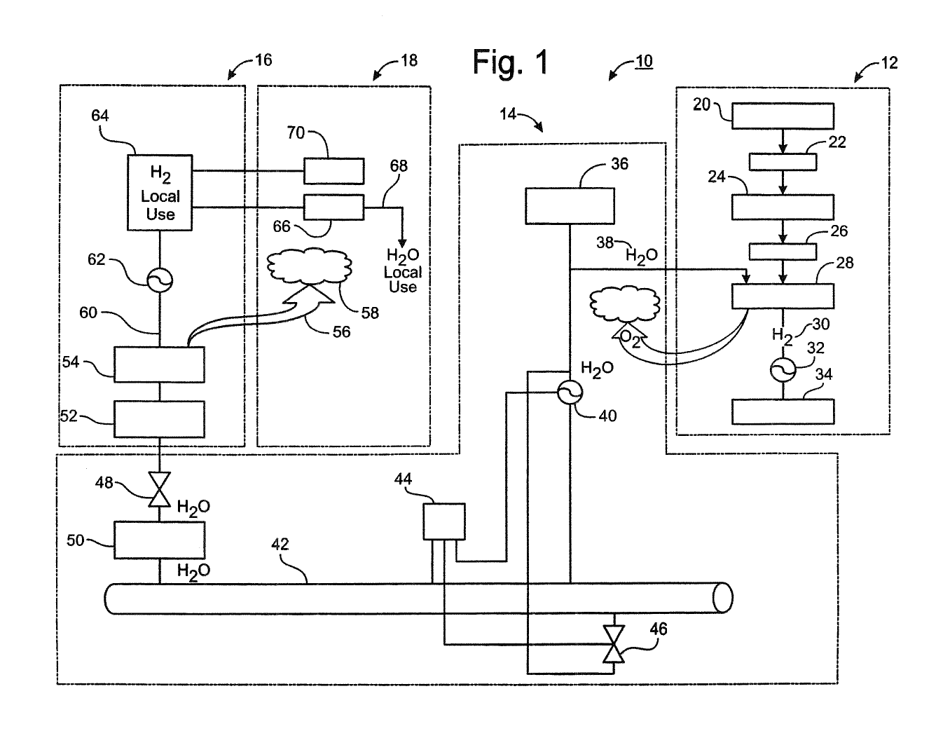

Turning now to FIG. 1 of the present disclosure, a Hydrogen-Based System for Conversion, Storage and Distribution of Energy from Renewable and Non-Renewable Sources is designated in general by the reference number 10. As shown, the Hydrogen-Based System 10 broadly includes a hydrogen production station or sector 12, a hydrogen supply and distribution system or sector 14, a hydrogen delivery sector 16, and a byproducts distribution and applications sector 18.

More particularly, the hydrogen production sector 12 in FIG. 1 may include an energy source 20, which provides energy 22 for a generating station 24 to produce electricity 26 for an electrolysis station 28. The generating station 24 may include a vertical-axis radial-flow tube or turbine as described in detailed below. The electrolysis station 28 produces hydrogen (H₂) in gaseous form 30. A hydrogen-injection pump 32 is provided to receive hydrogen 30 from the electrolysis station 28 and inject the hydrogen 30 into a hydrogen-distribution pipeline 42. The pipeline 42 may be constructed of, or lined with, a non-reactive material to address chemical and metallurgical issues associated with dissolving hydrogen in water.

The hydrogen supply and distribution sector 14 shown in FIG. 1 includes a water supply 36 to provide water (H₂O) 38 for the electrolysis station 28, and a water-injection pump 40 injects water 38 into the pipeline 42, which conveys hydrogen-containing water from a first geographic location to a second, perhaps distant, geographic location. As shown, a pressure-detecting system 44 may be provided for measuring pressure in the pipeline 42 and for controlling the water-injection pump 40 and a relief valve 46 to maintain proper pressure in the pipeline 42. A hydrogen-detecting system or meter 34 detects undissolved gaseous hydrogen 30 in the pipeline 42 and controls the water-injection pump 40 to increase pressure to force the undissolved gaseous hydrogen 30 into solution at the first location.

FIG. 1 further shows a meter 50 for measuring the hydrogen 30 discharged from the pipeline 42 and a vent valve 48 for removing water with dissolved hydrogen 30 from the pipeline 42 at a second location, possibly remote from the first location. The vent valve 48 directs the hydrogen 30 to a collecting chamber 52 in the hydrogen delivery sector 16 where the reduced pressure allows the dissolved hydrogen 30 to come out of solution. Here, a separator 54 separates the hydrogen 30 from other gasses 56 that have come out of solution. Those gasses 56 may be safely vented to atmosphere 58. Meanwhile, a transport tube 60 and a gas pump 62 move the hydrogen 30 from the separator 54 to a local use collection area 64, examples of such collection areas 64 being a fueling station for hydrogen-fueled vehicles and a power-generating station for generating electricity from the chemical energy in hydrogen. As shown, another collecting chamber 66 recovers the water 38 generated through use of the hydrogen 30 as fuel and a tube 68 distributes the water 38 as needed. Finally, a thermal-energy collecting device 70 recovers waste heat from the local use collection area 64 for use in heating, cooling or other purposes.

### Vertical-Axis Radial-Flow Turbine

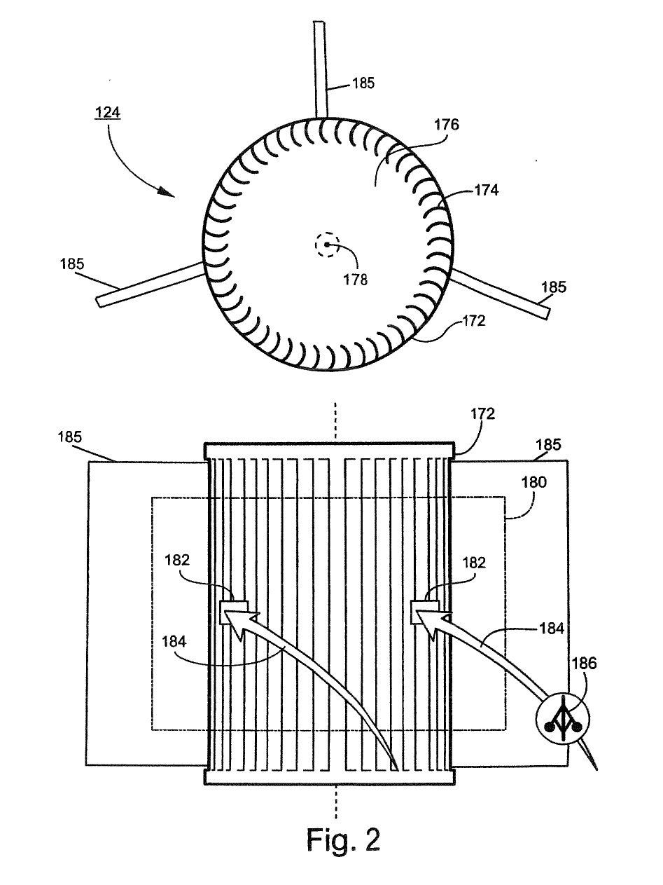

Turning now to FIG. 2, a vertical-axis radial-flow turbine 124 is shown in accordance with a particular aspect of the present disclosure. In this example, a body 172 is centered about a central vertical axis 178 of the turbine 124. The central vertical axis 178 may be present in the form of a rotatable spindle bearing, if so desired. This spindle bearing may be incorporated within the generator. The turbine 124 is cylindrical in shape, with a number of lift-producing vanes 174 arranged around a circumference of the body 172. As most clearly shown in the elevational view, the vanes 174 form vertical “walls” of the turbine 124. Fluid flow 184 over the vanes 174 creates lift that causes the turbine body 172 to rotate, with rotation occurring in the same direction regardless of the direction of fluid flow over the vanes 174. The turbine 124 is thus able to extract mechanical energy from a plurality of sources with fluid flows from multiple directions and vertical heights relative to the turbine axis 178.

Those skilled in the art will understand that the vanes 174 are not limited in number, size, shape or orientation shown in this example. The vanes 174 may be designed with various shapes and orientations to optimize lift at expected rotational speed and fluid flow for a specific application. Those skilled in the art will understand that the fluid flow 184 may be in various forms, including wind, forced air, steam, water, combustion gasses, and other fluid flows.

The circular-shaped top and bottom of the turbine body 172 (shown in FIG. 2) may be open or closed, depending upon the application. Also, a vertical-axis radial-flow turbine, such as the turbine 124, may be supported with various bearing systems (not shown) to allow rotation of the turbine body 172 in a variety of applications. By way of example, and not intended as a limitation, the turbine 124 may be mounted within or on an elevated structure, such as a tower or raised support structure, where the turbine 124 may be oriented to receive fluid flow.

Furthermore, although only one turbine body 172 is depicted in this example, multiple turbine stages may be arranged on the same axis (or spindle) 178, each with vanes 174 designed to maximize the extraction of energy from a particular fluid flow. Still further, multiple (radial- and/or axial-flow) turbine stages may be arranged concentrically around the same axis (or spindle bearing) 178, to maximize the extraction of energy from a fluid flow.

In order to accelerate and direct fluid flow for various design purposes, the vertical-axis radial-flow turbine 124 shown in FIG. 2 may have a manifold 180 arranged around an exterior and/or within the central interior cavity 176 of the turbine 124. As shown, for example, in the elevational view of FIG. 2, the manifold 180 could separate a particular fluid flow 184 into multiple streams and direct each stream 184 to an opposing arc of the manifold; this would balance the radial forces on the turbine body 172 to prevent the turbine 124 from experiencing “wobble” that might occur from unbalanced radial forces (notwithstanding the centrifugal forces that tend to keep such a spinning body from wobbling). One such manifold arrangement separates fluid flow 184 into three equal streams directed to three identical manifolds evenly distributed around the turbine body 172 with 120 degrees of angular separation, when viewed from above. The manifold 180 also may support elements of an integrated generator (not shown).

FIG. 2 further shows that a centrifugal flyweight governor or similar device 186 may be used alone, or as part of a governor, to control load and/or fluid flow 184, thereby causing the turbine 124 to operate at steady optimum rotational speed. The manifold 180 may have nozzles 182 to control fluid flow rate and to direct fluid flow at optimum speed, angle, and mass flow rate to create lift on the turbine's vanes 174, and these nozzles 182 may be controlled by the governor 186 to alter fluid flow rate to maintain steady optimum rotational speed. It is also possible to use multiple manifolds 180 on a single turbine 124 and/or to use fluid flows from different sources simultaneously. The nozzles 182 for each manifold 180 may be designed to convert thermal energy from fluid flow 184 into kinetic energy and to develop optimum speed, mass flow rate, and impingement characteristics for the particular fluid flow, vane design, and intended rotational speed of the turbine 124.

As briefly introduced, the vertical-axis radial-flow turbine 124 converts input energy into mechanical energy. The input energy may come from multiple sources, including renewable sources and stored energy in fuels, including H₂. As examples, the energy sources may include one or more of a wind source, a solar source, a hydro source, a geothermal source, a wave source, a bio-mass source, a waste energy source, a fossil fuel source, and a nuclear fuel source, some of which are discussed further herein. The vertical-axis radial-flow turbine 124 may serve as prime mover for a separate generator, or may be constructed so as to have a generator integrated within the turbine, or may serve as a prime mover for other purposes.

For instance, the physical structure of the vertical-axis radial-flow turbine 124 is generally the same configuration as the rotor of a squirrel cage induction motor, which may also function as a generator. The lifting vanes 174 that form the outer vertical cylindrical boundary of the turbine 124 function similarly to the rotor bars of the “squirrel cage.” If constructed from a conductive material, the body of the turbine 124 accordingly may serve as the rotor for a squirrel cage induction generator. When rotated, the turbine 124 may generate induced magnetic fields as a result of its shape and conductivity (with the assistance, if necessary, of “excitation current” from a stator that may be connected to an electrical grid).

When rotated within a stator with appropriate windings, the magnetic fields induced within the turbine 124 may impel the movement of electrons within the stator windings—that is, generate electricity. The stator windings may be integrated within the structure of the manifold 180 used to control and direct fluid flow across the lifting vanes of the turbine 124. In this way, the same physical components of the turbine 124 and manifold 180 may concurrently constitute the basic components of the generator, thereby eliminating the need to connect a separate generator to generate electricity with the turbine assembly. If appropriately designed and manufactured, this “component multi-tasking” may provide very significant cost savings compared to other generating systems. Furthermore, by specifically designing the characteristics of the integrated generator to optimize production in the given configuration, it may be possible to out-perform generators designed for a wider range of prime movers and uses.

### Wind Energy Embodiment

As briefly described and shown in FIG. 2, the vertical-axis radial-flow turbine 124 may be used as a wind turbine without the need for a steering mechanism. When airflow 184 meets the turbine 124, the aerodynamic characteristics of the overall cylindrical shape of the turbine 124 create a relatively high pressure area on the upwind side of the turbine 124 and a relatively low pressure area on the downwind side, resulting in a corresponding pressure change around the semi-circumferences of the turbine 124 (as seen from above) from upwind to downwind. The resulting differential pressures between the interior and exterior of the turbine body 172 at each vane position cause air flow across the turbine vanes 174. Thus, the air flow 184 from any horizontal direction creates lift across the turbine vanes 174 and causes the turbine body 172 to rotate.

Because no steering is required and because of the aerodynamic characteristics of the overall cylindrical shapes of the turbine 124, the turbine 124 may be used to extract wind energy from cross-sections of the fluid flow 184 that are much larger than the cross-section of the turbine 124. This functionality is accomplished by using outwardly projecting external structures 185 to enhance the pressure difference between the relatively high upwind pressure and the relatively low downwind pressure. For example, as shown in FIG. 2, three such external structures 185 may be arranged with 120 degrees of angular separation (as seen from above), each structure being located along a radius from the center of the turbine 124. Although three structures 185 are shown, other numbers of structures may instead be used.

These radially positioned structures 185 may be constructed of a material and in a configuration capable of withstanding high wind loads and may serve as nozzles to converge air flow 184 to a greater velocity and mass-flow rate across the vanes 174 of the turbine 124, as compared to the velocity and mass-flow rate achievable by mounting the turbine 124 without structures 185 in an ambient wind stream. By using external structures 185 to enhance air flow 184 across the turbine vanes 174, the turbine 124 of a particular size may thus be used to convert significantly more wind energy into mechanical energy than a similarly sized turbine without structures 185.

In addition to the turbine 124 being useful as a wind turbine, various embodiments of a vertical-axis radial-flow turbine are possible to convert other energy sources into mechanical energy. Embodiments may be combined to allow a vertical-axis radial-flow turbine to convert energy from multiple various sources simultaneously.

### Wave Enemy Embodiment

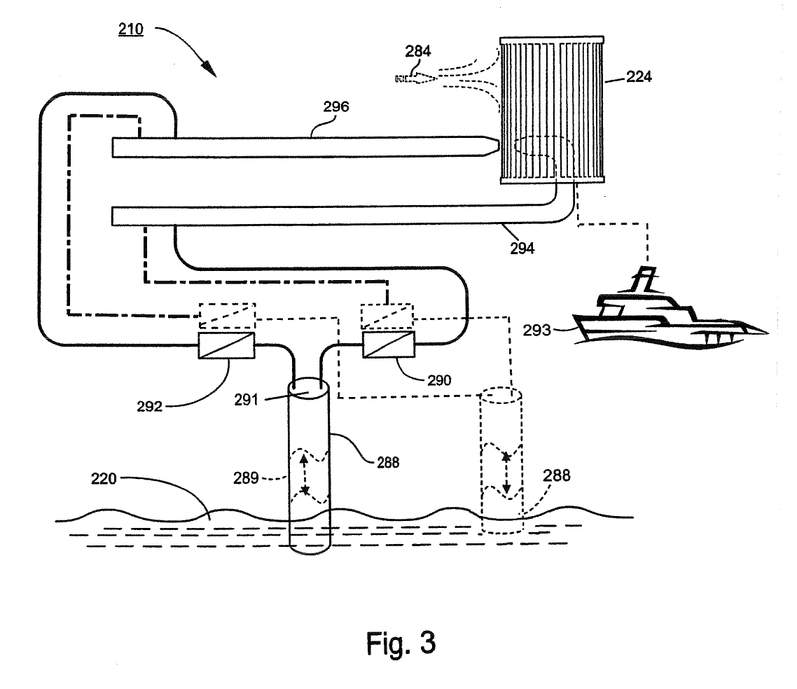

As shown in FIG. 3, a vertical-axis radial-flow turbine 224 may be used to extract mechanical energy from wave energy as part of an oscillating water column generator 210. As shown, when a tube 288 is placed vertically in a body of water 220, the bottom of which tube 288 is open to the water 220, passing waves will cause an internal column of water within the tube 288 to alternate rising and falling, as shown generally by element number 289. These internal wave oscillations 289 will cause the water column to operate like a piston within the tube 288, to alternately push air out of the tube 288 and pull air into the tube 288. With the tube 288 directing air flow to the turbine 224 or to a manifold of a turbine (such as manifold 180 in FIG. 2), the resulting oscillating airflow will create lift across the lift-producing vanes of the turbine 224 causing rotation of the turbine body.

An advantage of using the vertical-axis radial-flow turbine 224 as part of the oscillating water column generator 210, compared to other turbines such as a Wells turbine, is that the same vertical-axis radial-flow turbine 224 can simultaneously extract additional mechanical energy from the energy in wind 284. For instance, the turbine 224 may be mounted in an elevated structure to capitalize on the passing wind stream 284 while simultaneously extracting energy from internal wave oscillations 289. As FIG. 3 further shows, a cap 291 may enclose the top of the tube 288, so the oscillations 289 of the water column 289 cause air pressure above the water column 289 to increase and decrease with passing waves.

An out-flow check valve 292 in FIG. 3 allows air from above the water column to flow out of the tube 288 and into a higher-pressure plenum 296 as the rising water column 289 in the tube 288 increases the air pressure above the water column 289 to a sufficient higher-than-ambient pressure, but allows flow at no other time. An in-flow check valve 290 similarly allows air from a lower-pressure plenum 294 to flow into the tube 288 above the water column 289 as the falling water column 289 in the tube 288 reduces the air pressure above the water column 289 to a sufficient lower-than-ambient pressure, but allows flow at no other time. The lower pressure plenum 294 and the higher-pressure plenum 296 may lead directly to opposing positions across the vanes of the turbine 224 or to opposing nozzles or manifolds (similar to, e.g., manifold 180 in FIG. 2) of the vertical-axis radial-flow turbine 224. Thus, the higher-pressure plenum 296 will direct air across the vanes of the turbine 224 while at the same time the lower-pressure plenum 294 will draw air in the same direction across the vanes of the turbine 224. This flow control essentially adds the air flows of the higher-pressure plenum 296 and the lower-pressure plenum 294 together for greater speed and mass flow rate across the vanes of the turbine 224 than would be achieved without such flow control.

The oscillating water column generator 210, as in FIG. 3, also may take the form of a “Flow-Control Multiple Column Oscillating Water Column Generator” by having multiple tubes 288 (a second tube being shown in phantom for illustrative purposes), each separate tube 288 being open to water 220 and having respective flow-control devices 290, 292. As shown in FIG. 3, the in-flow control devices 290 from each tube 288 lead to the lower-pressure plenum 294, and the out-flow control devices 292 lead from each tube 288 to the higher-pressure plenum 296. The flow-control multiple-tube oscillating water column generator 210 thus allows the use of large numbers of tubes 288 to drive a single turbine 224 (which need not be a vertical-axis, radial-flow turbine if the simultaneous extraction of wind energy is not important), which significantly enhances the potential total output from a single turbine 224 to generate electricity on a utility scale when sufficient tubes 228 are used.

The oscillating water column generator 210 may also be fixed in place with its tube bottom positioned under the surface of water 220, or it may be mounted to or through a floating structure, such as a dock, barge or hull 293, which can be repositioned. While the floating hull 293 is depicted in FIG. 3 as a ship or yacht, other hull forms may be found useful or even superior. When the oscillating water column generator 210 is mounted to or through the floating hull 293, the floating hull 293 may be either connected to or disconnected from a shore-based facility (such as hydrogen production sector 12 and supply and distribution sector 14 described above) for transferring the converted energy. Such a floating hull 293 also may be propelled or towed to areas where wind and waves are more powerful than other places, for more effective conversion of energy. When not connected to a shore-based facility for transferring converted energy, such a floating hull 293 may use appropriate components from FIG. 1 to store chemical energy in the form of hydrogen dissolved in water under pressure, to be used later or offloaded later when connected to an appropriate shore-based facility. The oscillating water column generator 210 mounted to or through the floating hull 293 may extract energy not only from direct action of waves raising and lowering the water column, but also from the oscillation of the water column 289 induced by rocking of the hull 293 caused by wind and waves; the hull 293 may be designed with a particular hull shape and meta-centric height and other design factors to enhance the rocking of the hull 293 for enhanced energy extraction.

### Thermal Energy Embodiment

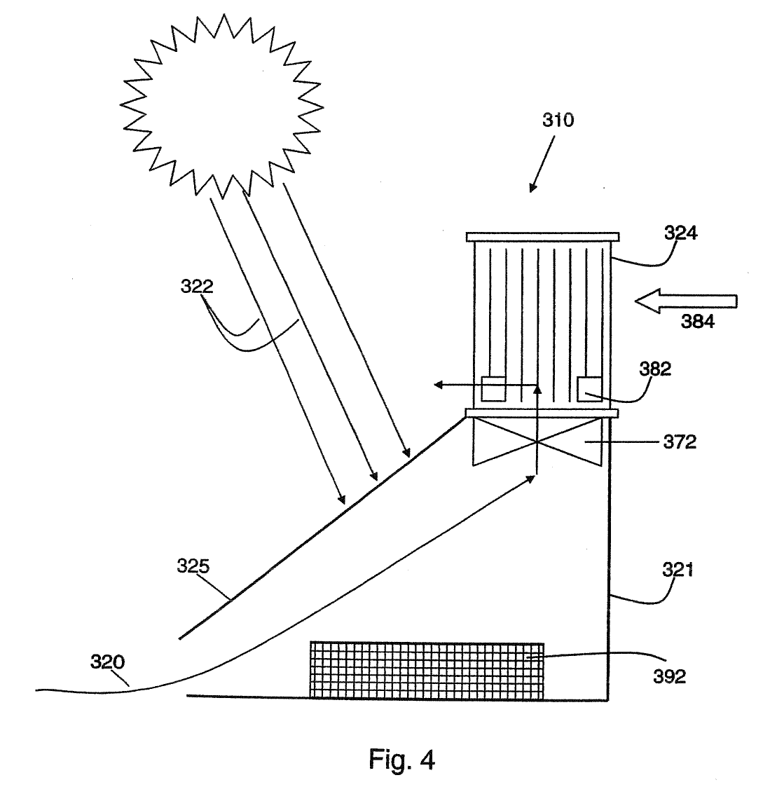

Turning to FIG. 4, a vertical-axis radial-flow turbine 324 may be used to convert thermal energy to mechanical energy as part of a generator system 310. The thermal generator 310 may use thermal energy 322 to generate air flow 320 through a thermal chimney 321 by means of natural convection due to the tendency of warmer, less dense air to rise and cooler, denser air to fall. Thermal energy 322 may be collected or generated from sources, such as solar radiation (captured by a collection surface 325), geothermal energy, the burning of fuel, or waste heat (for example, from cooling systems, heat engines, or other waste heat-producing processes, shown generically as heat-producing unit 392). A collection surface 325 may be used to convert impinging solar radiation into thermal energy 322. The resulting air flow 320 creates lift across the lift-producing vanes of the turbine 324, causing rotation of the turbine 324.

The output of the turbine 324 may be enhanced by using a turbo-charger or compression stage 372 to raise the pressure and velocity of the air flow 320 beyond what natural convection generates, thus allowing the nozzles 382 to convert thermal energy contained in the air flow 320 into kinetic energy to produce increased lift across the vanes of the turbine 324. The nozzles 382 also convert thermal energy contained in any water vapor in the air flow 320 into useful kinetic energy. The turbo-charger or compression stage 372 contemplated in this application is similar to those used in a jet-turbine engine to increase the pressure and velocity of air flow entering a nozzle, which enhances the nozzle's conversion of thermal energy to kinetic energy and allows the engine to produce greater output.

An advantage of the thermal generator 310 is its ability to simultaneously extract mechanical energy from multiple forms and sources of thermal energy 322. An advantage of using a vertical-axis, radial-flow turbine 324 as part of the thermal generator 310, when compared to other turbine types that could be employed, is that the vertical-axis radial-flow turbine may function as a wind turbine simultaneously with its function as a thermal turbine. For instance, the turbine 324 may be mounted in an elevated position to extract energy from passing wind streams 384, while concurrently converting thermal energy 322 into mechanical energy.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is set forth by way of example rather than by way of limitation, and the subject disclosure does not preclude inclusion of such modifications, variations and/or additions to the present subject matter as would be readily apparent to one of ordinary skill in the art.

That which is claimed is:

1. A hydrogen-based energy system comprising:
a generating station including a vertical-axis radial-flow turbine being configured to receive an energy source and to convert the energy source to electricity;
an electrolysis station powered by the electricity and being configured to produce and dispense hydrogen;
a water supply and distribution station being configured to provide water to the electrolysis station;
a hydrogen distribution system in communication with the electrolysis station for receiving the hydrogen and in communication with the water supply and distribution station for receiving water, the hydrogen being dissolved in the water under pressure for distribution; and
a separator and delivery system in communication with the hydrogen distribution system, the separator and delivery system configured for depressurizing, extracting and delivering the hydrogen for use as a fuel in a location disposed apart from the electrolysis station.

2. The hydrogen-based system as in claim 1, wherein the fluid energy source is selected from the group consisting of a wind source, a solar source, a hydro source, a geothermal source, a wave source, a bio-mass source, a waste energy source, a fossil fuel source, and a nuclear fuel source.

3. The hydrogen-based system as in claim 1, wherein the vertical-axis radial-flow turbine includes a plurality of vanes and is configured to extract mechanical energy simultaneously from a plurality of energy sources with flows from multiple directions and vertical heights relative to the turbine axis.

4. The hydrogen-based system as in claim 1, wherein the hydrogen distribution system includes a hydrogen distribution pipeline.

5. The hydrogen-based system as in claim 4, wherein the pipeline is constructed of or lined with a non-reactive material.

6. The hydrogen-based system as in claim 1, further comprising means for controlling input and output of hydrogen in the hydrogen distribution system.

7. The hydrogen-based system as in claim 6, wherein the means for controlling includes a pressure-detecting system and a hydrogen-detecting system to maintain desired pressure to maintain hydrogen fully dissolved in the water in the hydrogen distribution system without exceeding desired pressure.

8. The hydrogen-based system as in claim 1, wherein the location disposed apart from the electrolysis station is a fueling station for hydrogen-fueled vehicles.

9. The hydrogen-based system as in claim 1, wherein the location disposed apart from the electrolysis station is a power generating location for generating electricity from chemical energy in the hydrogen.

10. The hydrogen-based system as in claim 1, further comprising a thermal-energy collecting device to recover waste heat from the use of hydrogen, the waste heat being used for one of heating, cooling or an industrial process.

11. The hydrogen-based system as in claim 1, further comprising a collecting chamber and a tube for collecting and distributing water that is produced when hydrogen is used as fuel.

12. A method of using a mass distribution hydrogen energy system, the method comprising:
providing a pipeline having water therein, the pipeline having a first portion disposed at a first geographic location and a second portion disposed at a second geographic location;
dissolving hydrogen in the water under pressure in the pipeline proximate the first geographic location; and
depressurizing a quantity of the water from the pipeline to extract the hydrogen for use at the second geographic location.

13. The method as in claim 12, further comprising producing electricity for an electrolysis station.

14. The method as in claim 13, wherein further comprising providing a generating station having a vertical-axis radial-flow turbine, the generating station producing electricity for the electrolysis station.

15. The method as in claim 13, further comprising producing the hydrogen by the electrolysis station.

16. The method as in claim 12, further comprising controlling a pressure in the pipeline to maintain the hydrogen fully dissolved in the water in the pipeline.

17. The method as in claim 12, further comprising regulating removal of the hydrogen from the pipeline.

18. The method as in claim 12, further comprising separating the hydrogen from other gasses removed from the pipeline.

19. The method as in claim 11, further comprising using the hydrogen at an area disposed nearer the second geographic location than the first geographic location.

20. The method as in claim 19, further comprising generating electricity from the chemical energy in the hydrogen.

21. The method as in claim 19, further comprising recovering and using waste heat from using the hydrogen.

22. The method as in claim 19, further comprising collecting and distributing the water that is produced when the hydrogen is used as a fuel.

23. A vertical-axis radial-flow turbine system comprising:
a body defining a central vertical axis;
a plurality of vanes disposed about the central axis of the body, each of the vanes being configured to produce lift as a fluid flows across each vane causing the body to rotate, each of the vanes extracting energy from the fluid and converting the energy to produce mechanical energy; and
means for transferring the mechanical energy to a location apart from the turbine system.

24. The vertical-axis radial-flow turbine as in claim 23, further comprising a governor to control the flow of the fluid.

25. The vertical-axis radial-flow turbine as in claim 23, further comprising a nozzle to control a rate of the flow of the fluid and to direct the flow of the fluid.

26. The vertical-axis radial-flow turbine as in claim 23, further comprising a manifold to affect speed and impingement of the flow of the fluid.

27. The vertical-axis radial-flow turbine as in claim 26, wherein the body is made of an electrically conductive material to function as a rotor, and wherein the manifold is provided with stator windings, such that the rotation of the body relative to the manifold generates electricity.

28. The vertical-axis radial-flow turbine as in claim 23, further comprising a plurality of external structures extending radially from the body to enhance the pressure difference of the fluid flow across the vanes.

29. The vertical-axis radial-flow turbine as in claim 23, wherein the flow of the fluid is produced by thermal energy to produce lift and mechanical energy across the vanes.

30. The vertical-axis radial-flow turbine as in claim 29, wherein the thermal energy is selected from the group consisting of solar radiation, geothermal, fuel ignition, waste heat, steam and combinations thereof.

31. The vertical-axis radial-flow turbine as in claim 30, wherein the thermal energy is solar radiation collected in a thermal chimney, the thermal chimney being provided with a compression stage for increasing the pressure and velocity of the fluid flow.

32. A system for extracting mechanical energy from wave energy, the system comprising:
a tube having an opening disposed in a body of water, an internal column of water alternately rising and falling within the tube as a function of a movement of the body of water;
an outflow check valve in communication with the tube to permit air above the internal water column to flow out of the tube when the water column is rising in the tube and air pressure increases above the water column to a sufficient higher-than-ambient pressure;
a higher-pressure plenum configured to receive the air flowing out the tube;
an in-flow check valve in communication with the tube;
a lower-pressure plenum in communication with the in-flow check valve; and
a turbine in communication with the higher-pressure plenum and the lower-pressure plenum, such that the higher-pressure plenum directs airflow to an intake of the turbine, and the lower-pressure plenum draws airflow from an exhaust of the turbine to extract mechanical energy from the passing waves.

33. The system as in claim 32, further comprising multiple tubes, each tube having its own in-flow check valve and out-flow check valve, the in-flow check valve being in communication with the lower-pressure plenum and the out-flow check valve being in communication with the higher-pressure plenum.

34. The system as in claim 32, wherein the turbine is a vertical-axis radial-flow turbine.

35. A method of extracting mechanical energy from wave energy, the method comprising:
providing a turbine having an intake and an exhaust;
disposing a tube in a moving body of water, the tube having an opening therethrough to form a column of water within the tube;
pistoning the column of water in the tube;
allowing air from above the pistoning water column to flow out of the tube as a periodic function of the pistoning water in the tube and into a higher-pressure plenum as the water column rises in the tube and increases air pressure above the water column to a higher-than-ambient pressure, the higher-pressure plenum being disposed between the tube and the turbine and in fluid communication therewith;
allowing air from a lower-pressure plenum to flow into the tube above the water column as a periodic function of the pistoning water in the tube when the water column falls in the tube and reduces air pressure above the water column to a lower-than-ambient pressure;
directing airflow to the intake of the turbine from the higher-pressure plenum; and drawing airflow from an exhaust of the turbine by the lower-pressure plenum to extract mechanical energy from the moving body of water.

36. The method as in claim 35, wherein the turbine is a vertical-axis radial-flow turbine.

37. The method as in claim 35, further comprising joining the tube with a floating structure.

38. The method as in claim 35, further comprising disposing the turbine on a floating structure.
